(19) United States
(12) Patent Application Publication
(10) Pub. No.: US 2026/0066303 A1
(43) Pub. Date: Mar. 5, 2026

(54) BIPOLAR ELECTRODE AND METHOD FOR PRODUCING BIPOLAR ELECTRODE

(71) Applicant: TOYOTA JIDOSHA KABUSHIKI KAISHA, Toyota-shi Aichi-ken (JP)

(72) Inventors: Masashi UEDA, Toyota-shi Aichi-ken (JP); Nariaki MIKI, Okazaki-shi Aichi-ken (JP); Shinji KOJIMA, Nagoya-shi Aichi-ken (JP); Tomoko HIGO, Toyota-shi Aichi-ken (JP); Minehiro FUNATO, Toyota-shi Aichi-ken (JP)

(73) Assignee: TOYOTA JIDOSHA KABUSHIKI KAISHA, Toyota-shi Aichi-ken (JP)

(21) Appl. No.: 19/308,693

(22) Filed: Aug. 25, 2025

(30) Foreign Application Priority Data
Aug. 27, 2024 (JP) 2024-145952

(51) Int. Cl. H01M 4/62; H01M 4/02; H01M 4/04

(52) U.S. Cl. CPC H01M 4/623; H01M 4/0435; H01M 2004/021; H01M 2004/029

(57) ABSTRACT

A method for producing a bipolar electrode includes: mixing, under shear, a mixture containing a positive electrode active material or negative electrode active material and a binder resin, and a fibrillizable compound, to respectively prepare a positive electrode powder and a negative electrode powder; rolling the positive electrode powder and the negative electrode powder to respectively form a positive electrode layer and a negative electrode layer; and compressing the positive electrode layer and the negative electrode layer by respectively applying different pressures thereto, to respectively adjust a porosity of the positive electrode layer and a porosity of the negative electrode layer.

### CROSS-REFERENCE TO RELATED APPLICATION

This application is based on and claims priority under 35 USC 119 from Japanese Patent Application No. 2024-145952, filed on Aug. 27, 2024, the disclosure of which is incorporated by reference herein.

### TECHNICAL FIELD

The present disclosure relates to a bipolar electrode and a method for producing a bipolar electrode.

### BACKGROUND ART

In recent years, bipolar batteries have attracted attention from the viewpoint of improving volume energy density. A bipolar battery is obtained by stacking plural bipolar electrodes with a separator disposed therebetween.

Japanese Patent Application Laid-Open (JP-A) No. 2017-195076 discloses a bipolar-type battery, and the bipolar-type battery includes: a bipolar electrode including a bipolar current collector, a positive electrode mixture layer, and a negative electrode mixture layer; and a unit cell including a positive electrode having a positive electrode current collector and a positive electrode mixture layer, and a negative electrode having a negative electrode current collector and a negative electrode mixture layer, wherein the positive electrode has a positive electrode stack portion and a positive electrode terminal portion, the negative electrode has a negative electrode stack portion and a negative electrode terminal portion, a first solid electrolyte layer is arranged between the bipolar electrode and the positive electrode in a layer-stack direction of the bipolar-type battery, a second solid electrolyte layer is arranged between the bipolar electrode and the negative electrode in the layer-stack direction of the bipolar-type battery, and the first solid electrolyte layer and the second solid electrolyte layer are larger than the positive electrode and the negative electrode in an in-plane direction of the bipolar-type battery.

### SUMMARY

In a bipolar electrode, a positive electrode mixture layer is provided at one surface of a current collector, and a negative electrode mixture layer is provided at the other surface of the current collector. When an electrode mixture layer is formed at one surface of a current collector and pressed, warpage occurs at the electrode due to stress caused by elongation of the electrode mixture layer, and therefore, when producing a bipolar electrode, it is desirable to respectively provide electrode mixture layers at both surfaces of the current collector and then press the electrode mixture layers at the same time.

However, in order to improve input and output, a positive electrode layer of a bipolar electrode is required to have a high density, and a negative electrode layer is required to have a low density. In the case of the aforementioned method, since the positive electrode layer and the negative electrode layer have different compression characteristics with respect to pressing pressure, a problem arises in that the electrode density is too low in the positive electrode layer, or the electrode density is too high in the negative electrode layer.

An embodiment of the present disclosure is directed to provision of a bipolar electrode and a method for producing the same, wherein the porosity of a positive electrode layer and the porosity of a negative electrode layer are respectively adjusted to desired ranges.

A first aspect of the present disclosure provides a method for producing a bipolar electrode, the method including: a step of mixing, under shear, a mixture containing a positive electrode active material or negative electrode active material and a resin, and a compound selected from a fibrous compound or a fibrillizable compound, to respectively prepare a positive electrode powder and a negative electrode powder; a step of rolling the positive electrode powder and the negative electrode powder to respectively form a positive electrode layer and a negative electrode layer; and a step of compressing the positive electrode layer and the negative electrode layer by respectively applying different pressures thereto, to respectively adjust the porosity of the positive electrode layer and the porosity of the negative electrode layer.

In other words, the first aspect provides a method for producing a bipolar electrode, the method including:
separately mixing, under shear, each of a mixture containing a positive electrode active material and a resin, and a mixture containing a negative electrode active material and a resin, with a compound selected from a fibrous compound or a fibrillizable compound, to respectively prepare a positive electrode powder and a negative electrode powder;
rolling each of the positive electrode powder and the negative electrode powder to respectively form a positive electrode layer and a negative electrode layer; and
compressing the positive electrode layer and the negative electrode layer by respectively applying different pressures thereto, to respectively adjust a porosity of the positive electrode layer and a porosity of the negative electrode layer.

A second aspect of the present disclosure provides the method for producing a bipolar electrode according to the first aspect, wherein the fibrillizable compound is polytetrafluoroethylene (PTFE).

A third aspect of the present disclosure provides a bipolar electrode including: a positive electrode layer; a current collection foil; and a negative electrode layer, wherein the porosity of the positive electrode layer is lower than the porosity of the negative electrode layer, and a difference between the porosity of the positive electrode layer and the porosity of the negative electrode layer is 8% or more.

A fourth aspect of the present disclosure provides the bipolar electrode according to the third aspect, wherein the porosity of the positive electrode layer is from 20% to 26%, and the porosity of the negative electrode layer is from 36% to 42%.

According to an embodiment of the present disclosure, a bipolar electrode and a method for producing the same are provided, in which the porosity of a positive electrode layer and the porosity of a negative electrode layer are respectively adjusted to desired ranges.

### BRIEF DESCRIPTION OF DRAWINGS

FIG. 1 is a schematic diagram illustrating an example of the configuration of a bipolar electrode of the present disclosure.

### DETAILED DESCRIPTION

Hereinafter, a method for producing a bipolar electrode of the present disclosure will be explained, and through this explanation, details of a bipolar electrode of the present disclosure will be described.

The method for producing a bipolar electrode of the present disclosure includes a step of mixing, under shear, a mixture containing a positive electrode active material or negative electrode active material and a resin, and a compound selected from a fibrous compound or a fibrillizable compound, to respectively prepare a positive electrode powder and a negative electrode powder (hereinafter, also referred to as a “powder preparation step”), a step of rolling the positive electrode powder and the negative electrode powder to respectively form a positive electrode layer and a negative electrode layer (hereinafter, also referred to as a “rolling step”), and a step of compressing the positive electrode layer and the negative electrode layer by respectively applying different pressures thereto, to respectively adjust the porosity of the positive electrode layer and the porosity of the negative electrode layer (hereinafter, also referred to as a “compression step”).

Due to the method for producing a bipolar electrode of the present disclosure including the aforementioned steps, the porosity of the positive electrode layer and the porosity of the negative electrode layer can be respectively adjusted to desired ranges.

Respective details thereof will be explained below.

### -Powder Preparation Step-

In the powder preparation step, a mixture containing a positive electrode active material or negative electrode active material and a resin, and a fibrillizable compound, are mixed under shear to respectively prepare a positive electrode powder and a negative electrode powder.

The positive electrode powder contains a positive electrode active material and a resin.

Examples of the positive electrode active material include: lithium cobaltate (LiCoO₂, LCO); lithium nickelate (LiNiO₂, LNO); lithium manganate (LiMn₂O₄, LMO); lithium nickel cobalt manganate (Li(NiₓMn_{y}Co_{z})O₂ (x+y+z=1, 0<x<1, 0<y<1, and 0<z<1), NCM), such as NCM-111, NCM-523, NCM-622, or NCM-811; lithium aluminum cobalt nickel oxide (NCA); and lithium iron phosphate (LiFePO₄, LFP). The positive electrode active material can be appropriately selected from among these in accordance with, for example, desired battery performance.

The negative electrode powder contains a negative electrode active material and a resin.

Examples of the negative electrode active material include: carbon-based negative electrode active materials such as natural graphite, artificial graphite, and graphite; Li-based negative electrode active materials such as lithium titanate (for example, Li₄Ti₅O₁₂); and Si-based negative electrode active materials such as Si simple substance. The negative electrode active material can be appropriately selected from among these.

Examples of the resin used for the positive electrode powder or the negative electrode powder include polyvinylidene fluoride (PVdF), polyvinylidene fluoride-hexafluoropropylene copolymer (PVdF-HFP), styrene-butadiene rubber (SBR), carboxymethyl cellulose (CMC), and polyacrylic acid (PAA). Among these, polyvinylidene fluoride (PVdF) is desirable from the viewpoint of electrochemical stability and from the viewpoint of obtaining a positive electrode layer or a negative electrode layer that is a self-supporting film. By using PVdF, adhesion between components such as active materials in the powder can be improved.

The content of the resin is, for example, from 5 parts by mass to 10 parts by mass with respect to 100 parts by mass of the positive electrode active material or the negative electrode active material.

In embodiments, the mixture containing a positive electrode active material or negative electrode active material and a resin further contains a conductive agent for improving conductivity in order to improve battery performance. Examples of the conductive agent include carbon materials such as acetylene black, Ketjen black, vapor-phase carbon fibers (VGCF (registered trademark)), and carbon nanotubes (CNT). The content of the conductive agent is, for example, from 1 part by mass to 3 parts by mass with respect to 100 parts by mass of the positive electrode active material or the negative electrode active material.

As described above, in the powder preparation step, the mixture containing a positive electrode active material or negative electrode active material and a resin, and the compound selected from a fibrous compound or a fibrillizable compound, are mixed under shear to respectively prepare the positive electrode powder and the negative electrode powder. By mixing, under shear, the mixture containing a positive electrode active material or negative electrode active material and a resin, and the compound selected from a fibrous compound or a fibrillizable compound, the positive electrode active material or negative electrode active material and the resin can form a positive electrode powder or negative electrode powder in which the positive electrode active material or negative electrode active material and the resin are entangled with a compound having a fiber shape. Due to this configuration, a positive electrode layer that is a self-supporting film and a negative electrode layer that is a self-supporting film can be formed after the rolling step. It should be noted that, in the present disclosure, the term “self-supporting film” means a film that is capable of maintaining a shape as a film, even without a support (current collector).

Examples of the fibrous compound include carbon nanofibers (CNF) and carbon nanotubes (CNT).

Examples of the fibrillizable compound include polytetrafluoroethylene (PTFE) and ultra-high molecular weight polyethylene (UHMWPE).

Among these, polytetrafluoroethylene (PTFE) is desirable from the viewpoints of being easily fibrillized, functioning as a binder resin, and being desirable in oxidation resistance and reduction resistance.

In embodiments, the average particle diameter of the fibrous compound and a fibrillized product of the fibrillizable compound is from 200 μm to 700 μm (secondary particle diameter) from the viewpoint of obtaining a positive electrode powder and a negative electrode powder that form a positive electrode layer that is a self-supporting film and a negative electrode layer that is a self-supporting film.

Due to inclusion of the fibrous compound and the fibrillized product of the fibrillizable compound, it is easy to prepare a positive electrode powder and a negative electrode powder that can form a positive electrode layer and a negative electrode layer that are self-supporting films, after the rolling step.

The mixing under shear can be performed using a known kneading apparatus that is capable of exerting a shearing force, such as a colloid mill, a bead mill, an attritor, a three-roll mill, a two-roll mill, a dissolver, or a kneader.

In embodiments, during the mixing under shear, the rotational speed of a stirring mechanism (for example, a rotor blade) of the kneading apparatus is, for example, from 5 rpm to 20 rpm, and from the viewpoint of fibrillizing the fibrillizable compound, is from 5 rpm to 15 rpm, or from 9 rpm to 11 rpm.

In embodiments, the duration of mixing under shear is, for example, from 1 minute to 60 minutes in a case in which the rotational speed of the stirring mechanism of the kneading apparatus is from 9 rpm to 11 rpm, and from the viewpoint of fibrillizing the fibrillizable compound, is from 1 minute to 10 minutes.

The shape of the stirring mechanism is not particularly limited as long as a positive electrode layer that is a self-supporting film and a negative electrode layer that is a self-supporting film can be obtained after the rolling step, and can be appropriately selected in accordance with the kneading apparatus.

### -Rolling Step-

In the rolling step, the positive electrode powder or the negative electrode powder obtained in the powder preparation step is rolled to respectively form the positive electrode layer and the negative electrode layer. Due to inclusion of the present rolling step, a positive electrode layer that is a self-supporting film and a negative electrode layer that is a self-supporting film can be formed. Consequently, the compression step, which will be described later, can be performed.

The rolling can be performed using a roll press machine.

In embodiments, the pressing pressure at the time of rolling is from 0.1 t/cm to 1.5 t/cm, or from 0.3 t/cm to 0.5 t/cm, with respect to the positive electrode powder. Due to the pressing pressure at the time of rolling with respect to the positive electrode powder being in the aforementioned range, a positive electrode layer that is a self-supporting film can easily be obtained, and in the compression step, the porosity of the positive electrode layer can easily be adjusted to a desired range.

In embodiments, the pressing pressure at the time of rolling is from 0.01 t/cm to 1.0 t/cm, or from 0.03 t/cm to 0.05 t/cm, with respect to the negative electrode powder. Due to the pressing pressure at the time of rolling with respect to the negative electrode powder being in the aforementioned range, a negative electrode layer that is a self-supporting film can easily be obtained, and in the compression step, the porosity of the negative electrode layer can easily be adjusted to a desired range.

In embodiments, the roll temperature at the time of rolling is from 120° C. to 200° C., or from 140° C. to 180° C., with respect to the positive electrode powder. Due to the roll temperature at the time of rolling the positive electrode powder being in the aforementioned range, a positive electrode layer that is a self-supporting film can easily be obtained, and in the compression step, the porosity of the positive electrode layer can easily be adjusted to a desired range.

In embodiments, the roll temperature at the time of rolling is from 120° C. to 200° C., or from 140° C. to 180° C., with respect to the negative electrode powder. Due to the roll temperature at the time of rolling the negative electrode powder being in the aforementioned range, a negative electrode layer that is a self-supporting film can easily be obtained, and in the compression step, the porosity of the negative electrode layer can easily be adjusted to a desired range.

### -Compression Step-

In the subsequent compression step, different pressures are respectively applied to the positive electrode layer and the negative electrode layer obtained in the rolling step to compress the positive electrode layer and the negative electrode layer, whereby the porosity of the positive electrode layer and the porosity of the negative electrode layer are respectively adjusted to desired ranges. Due to inclusion of the present compression step, the porosity of the positive electrode layer and the porosity of the negative electrode layer are respectively adjusted to desired ranges. Consequently, the resistance of the positive electrode layer can be reduced and the resistance of the negative electrode layer can be reduced or maintained, whereby the internal resistance of the battery can be reduced.

The compression can be performed using a method that is capable of applying pressure to the positive electrode layer and the negative electrode layer, and examples thereof include a method of pressing with a hot plate and a method of passing through a pair of heating rolls (a method of passing through a pair of heating rolls using a roll press machine). Among these, the compression can be suitably carried out by a method of passing through a pair of heating rolls using a roll press machine.

In embodiments, the pressing pressure at the time of compression is from 0.8 t/cm to 2.0 t/cm, or from 1.0 t/cm to 1.8 t/cm, with respect to the positive electrode layer. In the present disclosure, the weight unit t or ton represents metric ton. Due to the pressing pressure at the time of compression being in the aforementioned range, the porosity of the positive electrode layer can easily be adjusted to a desired range.

In embodiments, the pressing pressure at the time of compression is from 0.1 t/cm to 0.7 t/cm, or from 0.2 t/cm to 0.5 t/cm, with respect to the negative electrode layer. Due to the pressing pressure at the time of compression being in the aforementioned range, the porosity of the negative electrode layer can easily be adjusted to a desired range.

In embodiments, the roll temperature at the time of compression is from 10° C. to 100° C., or from 20° C. to 50° C., with respect to the positive electrode layer. Due to the roll temperature at the time of compression being in the aforementioned range, the porosity of the positive electrode layer can easily be adjusted to a desired range.

In embodiments, the roll temperature at the time of compression is from 10° C. to 100° C., or from 20° C. to 50° C., with respect to the negative electrode layer. Due to the roll temperature at the time of compression being in the aforementioned range, the porosity of the negative electrode layer can easily be adjusted to a desired range.

In embodiments, after the compression, the porosity of the positive electrode layer is lower than the porosity of the negative electrode layer, and the absolute value of a difference between the porosity of the positive electrode layer and the porosity of the negative electrode layer is 8% or more. Due to the porosity of the positive electrode layer being at least 8% lower than the porosity of the negative electrode layer, the internal resistance of the entire battery can easily be kept low, without an electrode density of the positive electrode layer being too low, or an electrode density of the negative electrode layer being too high. Electrode density is related to the porosity of the electrode layer, and in view of keeping the internal resistance of the battery low, the positive electrode layer and the negative electrode layer are respectively adjusted to the porosities shown below.

In embodiments, after compression, the porosity of the positive electrode layer is from 20% to 26%, or from 21% to 25%. Due to the porosity of the positive electrode layer being from 20% to 26%, the resistance in the positive electrode layer is easily reduced, and the internal resistance of the battery is easily reduced. It is presumed that the decrease in resistance in the positive electrode layer is achieved due improvement in electron conductivity due to an increase in the electrode density of the positive electrode layer.

In embodiments, after compression, the porosity of the negative electrode layer is from 36% to 42%, or from 36% to 40%. Due to the porosity of the negative electrode layer being from 36% to 42%, the resistance in the negative electrode layer is easily reduced or maintained, and the internal resistance of the battery is easily reduced. It is presumed that the reduction or maintenance of the resistance in the negative electrode layer is achieved due to maintaining or improving diffusibility of lithium ions in the negative electrode layer due to a change in porosity before and after compression being small.

In embodiments, after compression, the difference between the porosity of the positive electrode layer and the porosity of the negative electrode layer is 8% or more, or 10% or more, from the viewpoint of reducing the internal resistance of the battery. In embodiments, the difference between the porosities is 22% or less, or 16% or less.

The porosity of the positive electrode layer can be calculated according to the following equation.

$$Porosity of positive electrode layer ( \% ) = \{ 1 - ( electrode density of positive electrode layer / true density of positive electrode layer ) \} \times 100$$

In the equation, the electrode density of the positive electrode layer is obtained by dividing the mass of the positive electrode layer by the product of the area of the positive electrode layer and the thickness of the positive electrode layer. The true density of the positive electrode layer is obtained by dividing the mass of the positive electrode layer (when the positive electrode layer consists of the positive electrode active material, the resin, and the conductive agent, the total mass of the positive electrode active material, the resin, and the conductive agent) by the volume of the positive electrode layer except for the volume occupied by voids. Therefore, it can also be said that the true density of the positive electrode layer is governed by inherent densities of the respective components constituting the positive electrode layer and the amounts of the respective components.

The true density can be measured using the gas displacement method. A measurement device using the gas displacement method may be automatic pycnometer ACCUPYC II 1340 manufactured by Micromeritics and compliant with ISO 12154:2014 and the like.

In the gas displacement method, in a system in which a sample chamber having a known internal volume (V_{CELL}) and an expansion chamber having a known internal volume (V_{EXP}) are connected to each other via a tube equipped with a valve, a sample is placed in the sample chamber. Gas is introduced only into the sample chamber among the sample chamber and the expansion chamber, so as to raise the pressure of the sample chamber to a stable pressure P₁ (pressure at pressurization). Thereafter, the valve disposed between the chambers is opened, whereby the gas in the sample chamber expands, as a result of which the pressure changes to P₂ (pressure at expansion). By measuring the pressure change, the sample volume (V_{SAMP}) (in the case of a positive electrode layer sample, the volume of the positive electrode layer except for the volume occupied by voids) can be calculated according to the following equation.

$${V}_{SAMP} = {V}_{CELL} - \frac{{V}_{EXP}}{\frac{{P}_{1}}{{P}_{2}} - 1}$$

The porosity of the negative electrode layer can be calculated according to the following equation.

$$Porosity of negative electrode layer ( \% ) = \{ 1 - ( electrode density of negative electrode layer / true density of negative electrode layer ) \} \times 100$$

In the equation, the electrode density of the negative electrode layer is obtained by dividing the mass of the negative electrode layer by the product of the area of the negative electrode layer and the thickness of the negative electrode layer. The true density of the negative electrode layer is obtained by dividing the mass of the negative electrode layer (when the negative electrode layer consists of the negative electrode active material, the resin, and the conductive agent, the total mass of the negative electrode active material, the resin, and the conductive agent) by the volume of the negative electrode layer except for the volume occupied by voids. Therefore, it can also be said that the true density of the negative electrode layer is governed by inherent densities of the respective components constituting the negative electrode layer and the amounts of the respective components.

The true density of the negative electrode layer can be measured using the same method as the method of measuring the true density of the positive electrode layer.

In the present step, a positive electrode layer that is a self-supporting film and a negative electrode layer that is self-supporting film, which have been adjusted in advance so that the porosities can be easily adjusted, can be used in the rolling step.

According to the method that has been explained above, the porosity of the positive electrode layer and the porosity of the negative electrode layer can be respectively adjusted to desired ranges. According to this method, the internal resistance of the battery can be reduced.

The method for producing a bipolar electrode of the present disclosure may further include, in addition to the aforementioned steps, a step of alternately stacking the positive and negative electrode layers with a bipolar current collector (current collection foil) disposed therebetween (hereinafter, also referred to as a “stacking step”).

As the bipolar current collector, one in which an aluminum foil and a copper foil are bonded together is suitably used. However, the type of the metal foil is not particularly limited as long as it is not decomposed or alloyed at the potentials of the positive electrode and the negative electrode.

The metal foil of the bipolar current collector may be one in which an adhesive layer or a carbon coating layer is provided at a surface thereof in order to improve wettability and adhesion to the positive electrode layer and the negative electrode layer.

An adhesive that is used for bonding of the metal foils to each other is not particularly limited, and for example, a polyolefin-based adhesive can be used. In embodiments, the adhesive contains a conductive agent in order to improve conductivity in the layer-stack direction of the bipolar battery. Examples of the conductive agent include nickel plated particles and carbon black.

The stacking step may be performed manually or may be performed by a stacker. A layered body that has been obtained by the stacking can be further rolled within a range in which the porosities do not change, and through this additional rolling step, a bipolar electrode is produced.

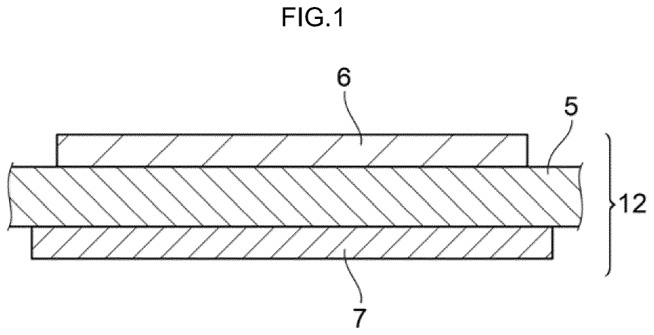

An example of the configuration of the bipolar electrode of the present disclosure is schematically illustrated in FIG. 1. As shown in FIG. 1, a bipolar electrode 12 according to the present disclosure includes a current collector foil 5, a negative electrode layer 6 disposed at one face of the current collector foil 5, and a positive electrode layer 7 disposed at the other face of the current collector foil 5.

### EXAMPLES

Hereinafter, embodiments according to the present disclosure will be explained in more detail with reference to examples, but embodiments according to the present disclosure are not limited to the following examples.

### Example 1

### (Preparation)

The following electrode materials were prepared.

### -Positive Electrode Powder-

Positive electrode active material: lithium nickel cobalt manganate (NCM)
Resin: PVdF
Conductive agent: carbon nanotubes
Fibrillizable compound: PTFE

### -Negative Electrode Powder-

Negative electrode active material: graphite
Resin: PVdF
Fibrillizable compound: PTFE

### -Bipolar Current Collector-

Bonded current collector (aluminum foil:conductive resin layer:copper foil=40:17:8 (μm))

### (Preparation of Bipolar Electrode)

A bipolar electrode was prepared according to the following procedures (1) to (7).

### (1) Positive Electrode Powder Preparation

The lithium nickel cobalt manganate (NCM) serving as a positive electrode active material, the PVdF serving as a resin, and carbon nanotubes serving as a conductive agent were mixed so that a ratio of positive electrode active material:resin:conductive agent=96.25:1.0:0.75 (mass ratio) was achieved, and the mixture was kneaded.

Next, the PTFE serving as a fibrillizable compound was mixed with this mixture so that a ratio of positive electrode active material:PTFE=96.25:2.0 (mass ratio) was achieved, and the mixture was further kneaded.

Next, shearing was applied to the kneaded material by a batch-type kneader (manufactured by Nihon Spindle Manufacturing Co., Ltd.) at a rotational speed of 10 rpm for 3 minutes, thereby fibrillizing the PTFE.

### (2) Rolling (Formation of Positive Electrode Layer Self-Supporting Film)

Next, the kneaded product containing the fibrillized PTFE was rolled by a roll press machine (manufactured by Tester Sangyo Co., Ltd.) at a pressing pressure of 0.4 t/cm and a roll temperature of 160° C., whereby a positive electrode layer that was a self-supporting film was prepared.

### (3) Compression (Adjustment of Porosity of Positive Electrode Layer)

Next, the positive electrode layer that was a self-supporting film was compressed by a roll press machine (manufactured by Nagano Automation Co., Ltd.) at a pressing pressure of 1.0 t/cm and a roll temperature of 25° C., so as to adjust the porosity of the positive electrode layer to the value in Table 1. The porosity of the positive electrode layer can be determined by the method described above.

### (4) Negative Electrode Powder Preparation

The graphite serving as a negative electrode active material and the PVdF serving as a resin were mixed so that a ratio of negative electrode active material:binder resin=94:5 (mass ratio) was achieved, and the mixture was kneaded.

Next, the PTFE serving as a fibrillizable compound was mixed with this mixture so that a ratio of negative electrode active material:PTFE=94:1 (mass ratio) was achieved, and the mixture was kneaded.

Next, shearing was applied to the kneaded material by a batch-type kneader (manufactured by Nihon Spindle Manufacturing Co., Ltd.) at a rotational speed of 10 rpm for 3 minutes, thereby fibrillizing the PTFE.

### (5) Rolling (Formation of Negative Electrode Layer Self-Supporting Film)

Next, the kneaded material containing the fibrillized PTFE was rolled by a roll press machine (manufactured by Nagano Automation Co., Ltd.) at a pressing pressure of 0.04 t/cm and a roll temperature of 160° C., whereby a negative electrode layer that was a self-supporting film was prepared.

### (6) Compression (Adjustment of Porosity of Negative Electrode Layer)

Next, the negative electrode layer that was a self-supporting film was compressed by a roll press machine (manufactured by Nagano Automation Co., Ltd.) at a pressing pressure of 0.5 t/cm and a roll temperature of 25° C., so as to adjust the porosity of the negative electrode layer to the value in Table 1. The porosity of the negative electrode layer can be determined by the method described above.

### (7) Preparation of Bipolar Electrode

The positive electrode layer that was a self-supporting film having an adjusted porosity and the negative electrode layer having an adjusted porosity were stacked with the bipolar current collector disposed therebetween and bonded by a roll press machine to obtain a bipolar electrode.

### Comparative Example 1

### (Preparation)

The following electrode materials were prepared.

### -Positive Electrode Powder-

Positive electrode active material: lithium nickel cobalt manganate (NCM)
Resin: PVdF
Conductive agent: carbon nanotubes

### -Negative Electrode Powder-

Negative electrode active material: graphite
Resin: SBR
Conductive agent: carbon nanotubes
Dispersant: carboxymethyl cellulose (CMC)

### -Bipolar Current Collector-

Bonded current collector (aluminum foil: conductive resin layer: copper foil=40:17:8 (μm), with carbon coating layer being formed at aluminum foil and copper foil surfaces)

### (Preparation of Bipolar Electrode)

A bipolar electrode was prepared according to the following procedures (1) to (3).

### (1) Positive Electrode Coating

A positive electrode slurry was prepared by mixing the lithium nickel cobalt manganate (NCM) serving as a positive electrode active material, the PVdF serving as a resin, and the carbon nanotubes serving as a conductive agent so that a ratio of positive electrode active material:binder resin:conductive agent=97.8:1.4:0.8 (mass ratio) was achieved, adding NMP, and kneading the mixture.

Next, the positive electrode slurry was coated at an aluminum foil side of the bipolar current collector using an applicator and dried to prepare a positive electrode layer.

### (2) Negative Electrode Coating

A negative electrode slurry was prepared by mixing the graphite serving as a negative electrode active material, the SBR serving as a binder resin, the carbon nanotubes serving as a conductive agent, and the CMC serving as a dispersant so that a ratio of negative electrode active material:binder resin:conductive agent: dispersant=97.95:1.6:0.05:0.4 (mass ratio) was achieved, adding water, and kneading the mixture.

Next, the negative electrode slurry was coated at a copper foil side of the bipolar current collector using an applicator and dried to form a negative electrode layer.

### (3) Compression

A bipolar electrode was prepared by compressing the bipolar electrode, at which the positive electrode layer and the negative electrode layer were respectively formed, by a roll press machine (manufactured by Nagano Automation Co., Ltd.) at a pressing pressure of 0.5 t/cm and a roll temperature of 25° C. The porosity of the positive electrode layer and the porosity of the negative electrode layer were determined according to the method described above. The results are shown in Table 1.

### Comparative Example 2

A bipolar electrode was prepared in the same manner as in Comparative Example 1 except that the pressing pressure and the roll temperature in the compression were 1.0 t/cm and 25° C., respectively, and the porosity of the positive electrode layer and the porosity of the negative electrode layer were determined. The results are shown in Table 1.

TABLE 1

| | | Comparative | Comparative |
|---|---|---|---|
| | Example 1 | Example 1 | Example 2 |
| Porosity of positive | 25% | 30% | 25% |
| electrode layer | | | |
| Porosity of negative | 36% | 36% | 31% |
| electrode layer | | | |

As can be understood from the results in Table 1, according to the method for producing a bipolar electrode of the present disclosure, the porosity of the positive electrode layer and the porosity of the negative electrode layer can be respectively adjusted to desired ranges. According to this method, the internal resistance of the battery can be reduced.

On the other hand, in the bipolar electrode of Comparative Example 1, since the positive electrode layer and the negative electrode layer were pressed at the same time aiming at achieving a desired porosity of the negative electrode layer (36% to 42%), the porosity of the negative electrode layer could be set in the desired range, but the porosity of the positive electrode layer became significantly greater than the desired range (20% to 26%). In the bipolar electrode of Comparative Example 2, since the positive electrode layer and the negative electrode layer were pressed at the same time, as in Comparative Example 1, aiming at achieving a desired porosity of the positive electrode layer (20% to 26%), the porosity of the positive electrode layer could be set in the desired range, but the porosity of the negative electrode layer became significantly smaller than the desired range (36% to 42%).

1. A method for producing a bipolar electrode, the method comprising:
mixing, under shear, a mixture containing a positive electrode active material or negative electrode active material and a resin, and a compound selected from a fibrous compound or a fibrillizable compound, to respectively prepare a positive electrode powder and a negative electrode powder;
rolling the positive electrode powder and the negative electrode powder to respectively form a positive electrode layer and a negative electrode layer; and
compressing the positive electrode layer and the negative electrode layer by respectively applying different pressures thereto, to respectively adjust a porosity of the positive electrode layer and a porosity of the negative electrode layer.

2. The method for producing a bipolar electrode according to claim 1, wherein the fibrillizable compound is polytetrafluoroethylene (PTFE).

3. A bipolar electrode comprising:
a positive electrode layer;
a current collection foil; and
a negative electrode layer,
wherein a porosity of the positive electrode layer is lower than a porosity of the negative electrode layer, and a difference between the porosity of the positive electrode layer and the porosity of the negative electrode layer is 8% or more.

4. The bipolar electrode according to claim 3, wherein the porosity of the positive electrode layer is from 20% to 26%, and the porosity of the negative electrode layer is from 36% to 42%.
